(19) United States
(12) Patent Application Publication
(10) Pub. No.: US 2011/0022976 A1
(43) Pub. Date: Jan. 27, 2011

(54) DYNAMIC USER INTERFACE SYSTEM

(75) Inventors: Chao-Ping Huang, Sunnyvale, CA (US); Sheng-Chun Yuan, Taipei (TW)

Correspondence Address: Jack Tsung-Yi Lin, P.O. Box 52113, Palo Alto, CA, 94303, US

(73) Assignee: CADexterity, Inc., Los Altos, CA (US)

(21) Appl. No.: 12/896,607

(22) Filed: Oct. 1, 2010

Related U.S. Application Data
(63) Continuation-in-part of application No. 11/766,350, filed on Jun. 21, 2007.

(51) Int. Cl. G06F 3/048

(52) U.S. Cl. 715/770; 715/810

(57) ABSTRACT

A user interface system for operating software on a computer includes a pointing device operable by a user's primary dexterous hand, a keyboard operable by the user's secondary dexterous hand, a matrix of keyboard keys on the keyboard. The matrix may include a first set of functions that are selected from a plurality of functions, and can be programmed to the matrix and displayed on the computer screen as a context menu. The selection of the functions being programmed to the matrix is dynamically linked to a previously executed function.

### RELATED APPLICATION

This application is a continuation in part application, and claims benefit under 35 U.S.C. §120 of U.S. patent application Ser. No. 11/766,350.

### BACKGROUND INFORMATION

The present application relates to a graphical user interface system. In particular, the present application relates to an improved dynamic graphical user interface system to allow users to operate a computer naturally and intuitively.

In a conventional user interface (UI) system to operate a computer, commands are often arranged in menus, and users rely on the mouse to navigate the UI. A user uses a mouse to navigate the menus, such as pull down and pop up menus, locates the desired command, and executes the command. This process is how a user typically interacts with the computer via a mouse, which requires repetitive mouse movement to fixed menu locations and extensive searches through the menu hierarchy in order to locate the appropriate command. This is a time-consuming process, and constantly interrupts a user's logical thought stream. Thus, the human-computer interaction is often a lagging factor in completing tasks on computers.

The reliance on the mouse to navigate and execute commands in UI environments contributes to the aforementioned lag. The mouse was not designed to execute multiple discrete functions quickly, and the number of inputs available on a mouse limits the optimal use of a user's hand. To illustrate this point, suppose that a typist types letters by selecting letters using a mouse. Typing under such condition will yield approximately 6-10 words per minute, which is substantially slower than the speed of 70-80 words per minute when typing with both hands on a keyboard. It is obvious that typing with mouse would, be extremely inefficient. On the other hand, relying on the keyboard as the sole interface to a computer is also disadvantageous as each key on the keyboard (or commands such as “CTRL-P” or “ALT-F”) must be pre-assigned with functions and only those pre-assigned functions can be performed.

As an example, the graphical UI in the CAD design software found on the market utilizes either the pop-up menu system or key binding system to navigate the software. Having the pop-up menu made the CAD design software easier to use. However, it constantly interrupts the user's train of thought. The key-binding system traded the “user friendliness” of the graphical UI with the older command-line driven interface, requiring the users to memorize commands and associating them to meaningless key combinations such as “CTRL-P” and “SHIFT-O”.

### SUMMARY

In accordance to some embodiments, a user interface system for operating software on a computer includes a pointing device operable by a user's primary dexterous hand, a keyboard operable by the user's secondary dexterous hand, a matrix of keyboard keys on the keyboard. The matrix may include a first set of functions that are selected from a plurality of functions, and can be programmed to the matrix and displayed on the computer screen as a context menu. The selection of the functions being programmed to the matrix is dynamically linked to a previously executed function.

### BRIEF DESCRIPTION OF THE DRAWINGS

The drawings illustrate the design and utility of preferred embodiments of the present application, in which similar elements are referred to by common reference numerals. In order to better appreciate how advantages and objectives of the present application are obtained, a more particular description will be rendered by reference to specific embodiments thereof, which are illustrated in the accompanying drawings. Understanding that these drawings depict only typical embodiments and are not therefore to be considered limiting of the scope of this application. This application seeks to describe and explain with additional specificity and detail through the use of the accompanying drawings in which:

FIG. 1A illustrates an embodiment of operating the user interface system;

FIG. 1B illustrates another embodiment of operating the user interface system;

FIG. 2 illustrates an exemplary embodiment of the matrix and associated menu;

FIG. 3 illustrates an exemplary embodiment of available functions on the pointing device;

FIG. 4 illustrates an exemplary embodiment of the view depth alteration menu;

FIG. 5 illustrate different viewing mode available in the exemplary embodiment.

### DETAIL DESCRIPTION

Various embodiments of the present application are described hereinafter with reference to the figures. It should be noted that the figures are not drawn to scale and elements of similar structures or functions are represented by like reference numerals throughout the figures. It should also be noted that the figures are only intended to facilitate the description of specific embodiments of this application. They are not intended as an exhaustive description or as a limitation on the scope of this application. In addition, an aspect or a feature described in conjunction with a particular embodiment of the present application is not necessarily limited to that embodiment and can be practiced in any other embodiments of the present application.

This application generally describes a novel user interface system. Most users have a dexterous primary hand and a relatively less dexterous secondary hand. The user interface system described herein allows all spatial motion to be controlled by the dexterous hand while using the other hand for executing a subset of relevant commands under a particular environment to dynamically optimize use of both primary and secondary hands to manipulate the software environment. By organizing the commands into spatial commands and functional commands, the user can operate the software efficiently and uninterruptedly by dedicating operations requiring movements to the primary hand using a pointing device (i.e., a mouse) while dedicating execution of commands and functions to the secondary handing using the keyboard.

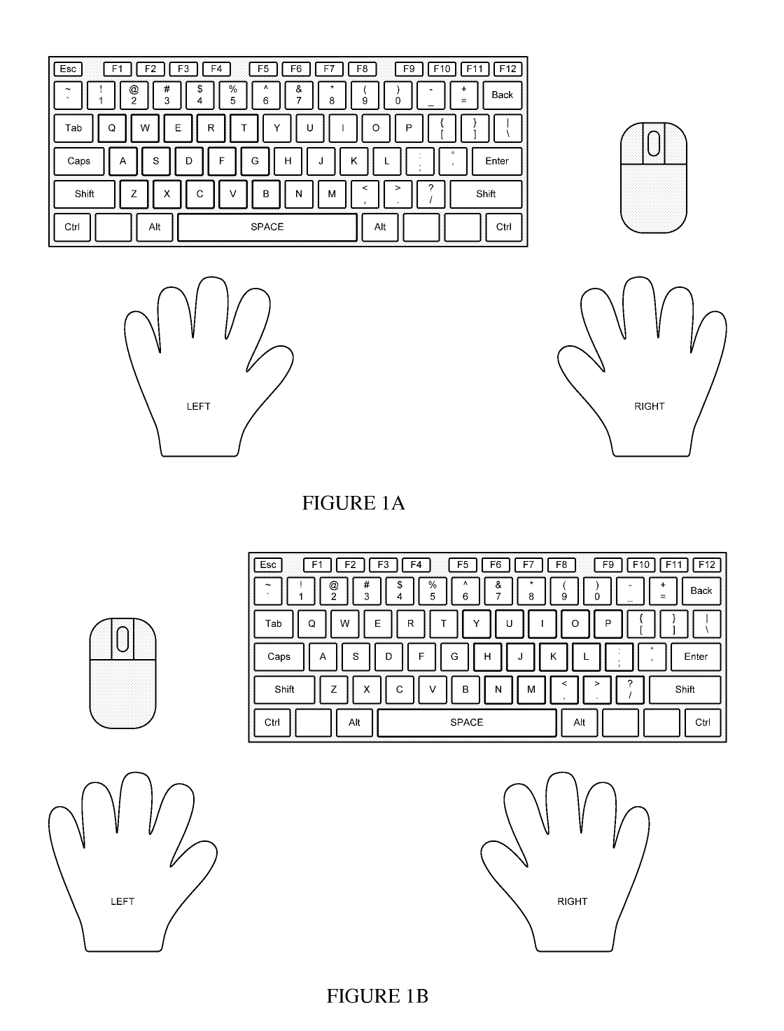

The user controls the pointing device (i.e., using a mouse, a type of pointing device, to control the spatial movement of a cursor), the buttons on the pointing device, and the scroll wheel on the pointing device (if available on the pointing device) with the primary, more dexterous hand. The user also controls the space key and the keys that are easily accessible with the secondary hand or the hand not operating the pointing device. The keys that are easily accessible with the secondary hand can be defined by the location of the secondary hand. Keys that are easily accessible can be further defined by the natural reach of the secondary hand. The set of keys operable by the secondary hand can also be defined by a matrix. In one instance, 15 keyboard keys on the keyboard are mapped to one of two sets of three by five matrices. When the secondary hand is the left hand, the 15 keys of the three by five matrix consist of: (1) keys Q W E R T mapped to a top row of said three by five matrix; (2) keys A S D F G mapped to a middle row of said three by five matrix; and (3) keys Z X C V B mapped to a bottom row of said three by five matrix (See FIG. 1A). Alternatively, when the secondary hand is the right hand, the 15 keys of the three by five matrix consists of: (1) keys Y U I O P mapped to a top row of said three by five matrix; (2) keys H J K L ; mapped to a middle row of said three by five matrix; and (3) keys N M , . / mapped to a bottom row of said three by five matrix (See in FIG. 1B). The space key, in addition to the two sets of three by five matrices, is used in conjunction by the secondary hand. Alternatively, the matrix assigned to the left hand can also be a four by five matrix, which further includes keys 1 2 3 4 5 in addition to the three by five matrix defined above; the matrix assigned to the right hand can also be another four by five matrix, which further includes keys 7 8 9 0 - in addition to the three by five matrix defined above.

The matrix and the space key can be configured to display the function of each key, and the function assigned to each key can be customizable to fit the user's preference. All commands of the software are dynamically linked thus all commands can be available to user thru the combination of the aforementioned keys and pointing device. As configured, the interface system bypasses the act of selecting a function from the menu tree in the traditional user interface.

In the instance of a user operating software through the user interface system on a computer, the user may select a software function using the pointing device or a command key, and the sub-functions relevant to the selected function may be automatically assigned to the matrix and the space key. Functions requiring motion manipulation are assigned to the pointing device and the keys on the pointing device. The assignment of functions and sub-functions to the matrix and pointing device is dynamically linked, wherein selecting any function may effectuate changes in the assignment of function to the matrix, the space key, the pointing device, and the keys on the pointing device. A context menu specific to the functions-assigned matrix may be displayed on the computer screen. The contextual menu displayed on screen can be hidden or minimized to allow for more desktop drawing space. The sub-functions are logically assigned to the keys of the matrix to fit the user's intuition. In the same instance, selecting a sub-function from the matrix may further update the functions assigned to the matrix, the context menu, and the pointing device to the sub-sub-functions relevant to the selected sub-function. As an example of the dynamic interface system, when the user selects the function “move object” resulting in functions relevant to “move object,” such as “zoom in,” “zoom out,” “rotate clockwise,” “rotate counter-clockwise” being assigned to the matrix and displayed on the context menu, the pointing device is further enabled to move and manipulate objects on the computer screen.

In an exemplary embodiment, the interface system as applied in a CAD design software is described below. As the user attempts to manipulate the chip being designed, functions relevant to that particular manipulation are “routed” to the matrix and the space key and are made available to the user. Buttons on the pointing device are also assigned functions that are specific to that manipulation.

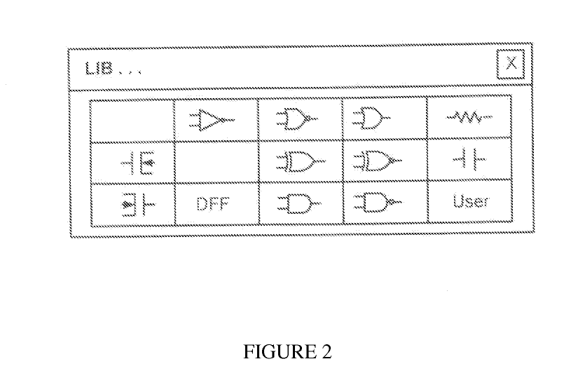

Referring now to the figures, FIG. 2 depicts an embodiment of the interface system showing the context menu that was generated after the function LIBRARY is selected. The functions shown on the context menu are assigned to a matrix and arranged to correspond to physical keyboard keys. If the user uses the left hand to operate the key matrix on a standard QWERTY keyboard, the fifteen keys on the matrix consist of a top row QWERT, a middle row ASDFG, and a bottom row ZXCVB (See FIG. 1A). The matrix may be assigned up to 15 commands, as shown by the context menu displayed on the computer monitor. Alternatively, the matrix can be assigned up to 20 commands. Each command can be executed by pressing a corresponding keyboard key. The context menu on the screen is a visual representation of the pattern of keys on the keyboard. Thus, the keyboard key is said to be “mapped” to the command.

Functions and commands can be customized to each key of the matrix based on each user's needs. In one embodiment, the user may assign function to each key of the matrix by “dragging and dropping” a function onto a key of the matrix (i.e., using the pointing device to assign a function to the keys of the matrix by selecting the function and linking it to the key). In another embodiment, the user may also use cut and paste commands to customize the keypad layout. For example, if the user would like to execute the resistor command in FIG. 2 with keyboard ‘r’, then the user may drag the resistor symbol using the pointing device and it on the key mapped to the button ‘r’. The resistor command would replace the command it replaces.

Command keys can also be case sensitive. In an alternative embodiment, only lower-case characters are assigned with commands. The shift button can be reserved for other functions. In one of the embodiments, pressing “Shift+key” may display a one-line description for the specific 25, command assigned to that particular key on the screen. In another embodiment, the one-line description can also be displayed by hovering the cursor over a key in the context menu.

A user can return to a higher level contextual menu in the command hierarchy (e.g., returning from a sub-command contextual menu to a higher hierarchy command contextual menu) by pressing the right button on a pointing device such as a mouse or any button on the pointing device that has been assigned the function of returning to higher hierarchy contextual menu. For example, the user can exit the File keypad menu by pressing the right button to return to the Main keypad menu.

In another embodiment, object sensitivity functionality automatically presents only those options that a user is limited to within a particular environment (e.g., selecting an object on the chip design schematics). A specific object-sensitive context menu (or matrix) can be activated based on the selected object. For an example, when a resistor is selected on the visualized chip, the resistor-specific context menu (or matrix, or environment) is activated when a resistor is selected.

In another embodiment, when selecting an object on the chip via the pointing device in a congested area (e.g., when designing a semiconductor chip using the CAD design software, the part of the semiconductor chip having clustered electronic components), it is often that the first selection may not be correct. In this embodiment, the user may keep the cursor stationary above the congested area and click the left button on a pointing device such as a mouse repeatedly, each click will deselect the previously selected object and the next nearest object will be selected and high-lighted. This iterative selection mechanism simplifies selections in congested areas.

In another embodiment, the middle button on a pointing device such as a mouse may be used to assign a function to a key in the matrix. The user may use the middle button to first select a desired function, then move the pointing device and click the left button on the key in the contextual menu to connect or link a function to a key. In this embodiment the user may “connect the dots” between the function and one of the keys to assign the function to the key.

In another embodiment, the user may use the right button on the pointing device similarly to the “Esc” function on a computer. A single click on the right pointing device button reverses the previous action performed and acts similar to an Undo operation. For example, after selecting a number of objects, clicking the right button will deselect all the selected objects.

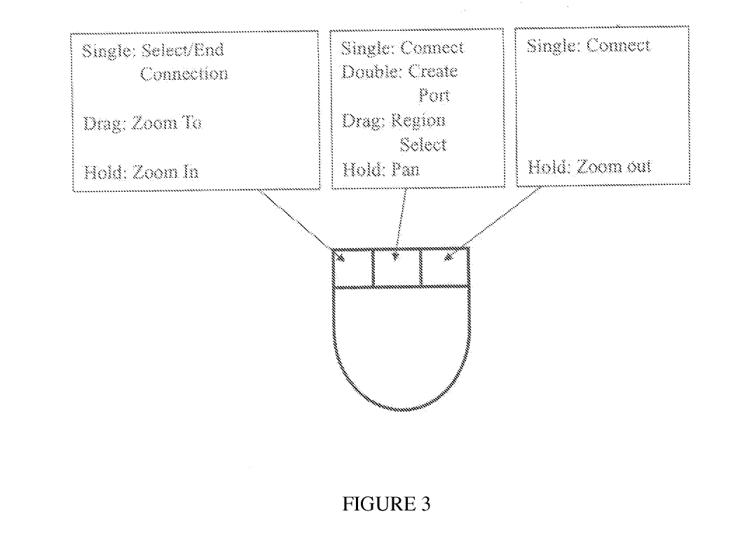

The functions on the pointing device are summarized in FIG. 3. The user interface in the CAD design example allows a user to maneuver the user's view. The user can zoom in, zoom out and pan via the mouse. This allows the user to interact with the virtual environment as needed.

In one embodiment, the user may use the left and right button on the pointing device to zoom in or out of an area on the desktop. A user can zoom into a particular region by holding down the left button and then dragging the cursor to form a rectangle around the region to be zoomed. The region within the rectangle will zoom in. Alternatively, a user can zoom into a particular location as by holding the left button at the desired location. To zoom out, hold the right button.

In another embodiment, the user may use the middle button to select a region and all of the objects within the region. A user can quickly select multiple objects by holding down the middle button and by dragging the cursor to form a rectangular region. All objects that are completely enclosed by region will be selected.

In another embodiment, the user may use the middle button to pan. By holding down on the middle button, a user can perform a continuous pan operation relative to the center of the window.

In another embodiment, the user may selectively group items into a new sub-block. The Group command will put all of the selection items into a new block at a deeper level of design hierarchy. The Group command may be useful in associating basic geometry objects so that they somewhat move and behave as a single unit. The Group command is accessible from the EDIT keypad when multiple items are selected.

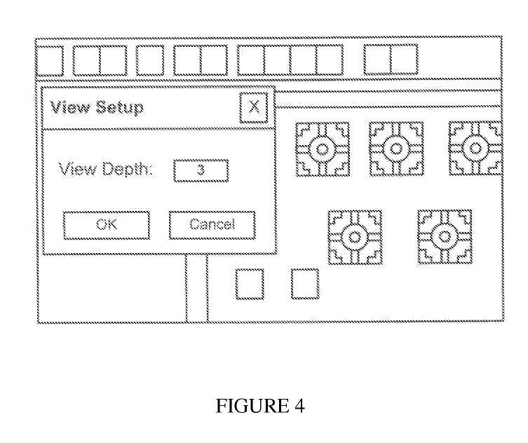

The user interface in the CAD design example also allows a user to maneuver the user's view by altering view depth. As illustrated in FIG. 4, clicking the view depth menu can be selected to alter the view depth, which controls the levels of hierarchy that are visible from the currently opened design. The viewing depth can be set from the application tool bar.

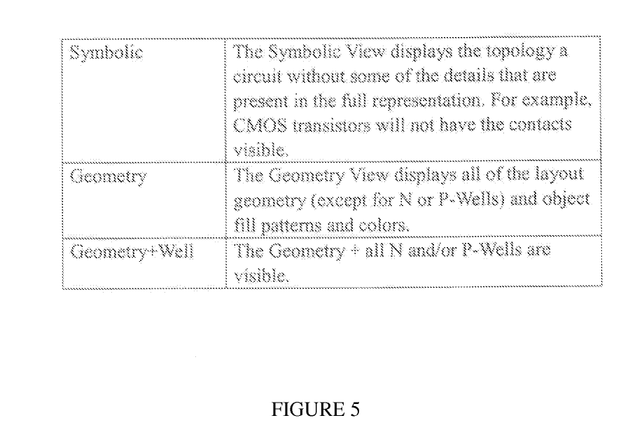

The user interface in the CAD design example may have multiple viewing modes for the user to select. The ability to switch viewing modes from the key matrix allows the user to quickly display or remove detail depending upon the need. The viewing modes may be selected from the toolbar, as well as from the key matrix. Filters can be used to selectively omit different details on the circuit. Once configured, a user can swap between different selection filters through the keypad or by activating the appropriate selection preference tab. Three of the viewing modes are illustrated in FIG. 5:

SYMBOLIC: The Symbolic View mode displays the topology of a circuit omitting some of the details that are present in a full, detailed representation of the circuit. For example, CMOS transistors will not have the contacts visible.

GEOMETRY: The Geometry View mode displays all of the layout geometry (except for N or P-wells) and object fill patterns and colors.

GEOMETRY+Well: The Geometry+Well mode shows all N and/or P-Wells.

Although particular embodiments of the present application have been shown and described, it will be understood that it is not intended to limit the present application to the preferred embodiments, and it will be obvious to those skilled in the art that various changes and modifications may be made without departing from the spirit and scope of the present application. For example, the user interface can be applied to other software applications, such as gaming controls and graphic design, and should not be limited to particular embodiments comprising a particular application of the present application. The specification and drawings are, accordingly, to be regarded in an illustrative rather than restrictive sense. The present application is intended to cover alternatives, modifications, and equivalents, which may be included within the spirit and scope of the present application as described herein. As an example, the user interface (UI) described herein can be configured to adapt to gaming software. In the instance of the UI adapted to a role playing game, a character controlled by the user, is given the command to pick up a weapon in the virtual environment by selecting the corresponding key on the keyboard or by using the pointing device to execute the command. As the character picks up and holds the weapon, the matrix and the corresponding context menu would be dynamically assigned a new set of commands that are specific to utilize the weapon in hand. As another example, the UI described herein can also be configured to adapt to image manipulation software. In such a configuration, the user may select different photo manipulation functions, and the matrix would be dynamically changed as the user selects different functions.

What is claimed is:

1. A user interface system for operating software on a computer, comprising:
a pointing device operable by a user's primary dexterous hand;
a keyboard operable by the user's secondary dexterous hand;
a matrix of keyboard keys on the keyboard, wherein a first set of functions, selected from a plurality of functions, is programmable to the matrix and are displayable on the computer screen as a context menu; and
wherein the selection of the functions being programmed to the matrix is dynamically linked to a previously executed function.

2. The user interface system of claim 1, wherein the matrix of keyboard keys is defined by a location of the secondary dexterous hand on the keyboard.

3. The user interface system of claim 2, wherein the matrix of keyboard keys operable by the secondary dexterous hand being the left hand comprises “Q”, “W”, “E”, “R” “T” “A”, “S”, “D”, “F”, “G” “Z”, “X” “C”, “V”, “B” and the space bar.

4. The user interface system of claim 2, wherein the matrix of keyboard keys operable by the secondary dexterous hand being the right hand comprises “Y”, “U”, “I”, “O”, “P” “H”, “J”, “K”, “L”, “;”, “N”, “M”, “,”, “.”, “/” and the space bar.

5. The user interface system of claim 1, wherein the functions programmed to the pointing device comprises motion manipulation functions, object selection functions, display manipulation functions, and spatial manipulation functions.

6. The user interface system of claim 1 further comprises a second set of functions, selected from the plurality of functions, is programmable to the matrix and the pointing device.

7. The user interface system of claim 6, wherein the selection of the functions being programmed to the matrix and the pointing devices is dynamically linked to the previously executed function.

8. The user interface system of claim 1, wherein executing any function programmed to the matrix selects another first set of functions linked to the executed function being programmed to the matrix.

9. The user interface system of claim 7, wherein executing any function programmed to the matrix or the pointing device selects another second set of functions linked to the executed function being programmed to the U) matrix and the pointing device.

10. The user interface system of claim 1, wherein a user can program the first set of functions to the matrix.

11. The user interface system of claim 7, wherein a user can program the second set of functions to the matrix and the pointing device.

12. The user interface system of claim 10 or 11, wherein the programming comprises drag and drop, cut and paste, or hyperlink.
